(19) United States
(12) Patent Application Publication
(10) Pub. No.: US 2021/0312822 A1
(43) Pub. Date: Oct. 7, 2021

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Ryota NAKABAYASHI, Toyota-shi (JP); Naoki YAMADA, Toyota-shi (JP); Daigo FUJII, Tsushima-shi (JP); Atsushi IKEGAYA, Nagoya-shi (JP)

(73) Assignee: TOYOTA JIDOSHA KABUSHIKI KAISHA, Toyota-shi (JP)

(21) Appl. No.: 17/215,165

(22) Filed: Mar. 29, 2021

(30) Foreign Application Priority Data
Apr. 3, 2020 (JP) 2020-067860

(51) Int. Cl. G08G 5/02; B64F 1/00

(52) U.S. Cl. CPC G08G 5/02; B64F 1/007

(57) ABSTRACT

An information processing apparatus of the disclosure of the present application includes a controller that is configured to acquire landing information about landing of a flying object on a landing platform that is provided on a housing facility for housing the flying object, the landing platform being where the flying object lands when the flying object is to be housed in the housing facility, the landing platform being movable between a stored state of being stored in an inner space separated by an outer wall of the housing facility and a protruding state of protruding from the outer wall of the housing facility, and issue a command for controlling the landing platform to be in the stored state, based on the landing information.

### CROSS REFERENCE TO THE RELATED APPLICATION

This application claims the benefit of Japanese Patent Application No. 2020-067860, filed on Apr. 3, 2020, which is hereby incorporated fey reference herein in its entirety.

### BACKGROUND

### Technical Field

The present disclosure relates to an information processing apparatus and an information processing method.

### Description of the Related Art

Patent Literature 1 discloses a technology related to a flying car that is capable of traveling in air and on land. According to the technology, wings, a propulsion unit and the like are housed in a body at the time of traveling on land, and are deployed in a reverse operation at the time of flying. Furthermore, a dual-purpose power source is used, and power that is transmitted to wheels at the time of traveling on land is transmitted, via a power transmission switching device, to a propeller at the time of flying.

[Patent document 1] Japanese Patent Laid-Open No. 2004-82992

### SUMMARY

An object of the present disclosure is to provide an information processing apparatus and an information processing method that are capable of promoting use of flying objects.

An information processing apparatus according to the disclosure of the present application includes a controller configured to acquire landing information about landing of a flying object on a landing platform that is provided on a housing facility for housing the flying object, the landing platform being where the flying object lands when the flying object is to be housed in the housing facility, the landing platform being movable between a stored state of being stored in an inner space separated by an outer wall of the housing facility and a protruding state of protruding from the outer wall of the housing facility, and issue a command for controlling the landing platform to be in the stored state, based on the landing information.

Furthermore, an information processing apparatus according to the disclosure of the present application includes a controller configured to acquire landing information about landing of a flying object on a landing platform that is provided on a housing facility for housing the flying object, the landing platform being where the flying object lands when the flying object is to be housed in the housing facility, the landing platform including a part that is stored in an inner space separated by an outer wall of the housing facility and a remaining part that protrudes from the outer wall of the housing facility, the landing platform being rotated around a virtual axis that is substantially perpendicular to the landing platform such that a protruding part, of the landing platform, that protrudes from the outer wall of the housing facility and a stored part, of the landing platform, that is stored in the inner space of the landing platform are switched, and issue a command for controlling a rotation operation of the landing platform, based on the landing information.

Furthermore, the disclosure of the present application may also be understood as an information processing method that is performed by a computer. That is, according to the information processing method of the disclosure of the present application, a computer acquires landing information about landing of a flying object on a landing platform that is provided on a housing facility for housing the flying object, the landing platform being where the flying object lands when the flying object is to be housed in the housing facility, the landing platform being movable between a stored state of being stored in an inner space separated by an outer wall of the housing facility and a protruding state of protruding from the outer wall of the housing facility, and issues a command for controlling the landing platform to be in the stored state, based on the landing information.

According to the disclosure of the present application, use of flying objects may be promoted.

### BRIEF DESCRIPTION OF THE DRAWINGS

FIG. 1 is a diagram illustrating a schematic configuration of an information processing system according to a first embodiment;

FIG. 2 is a diagram illustrating the structural elements of the information processing system according to the first embodiment in greater detail;

FIG. 3 is a flowchart of a process performed by a server in the first embodiment to house an unmanned aircraft in a housing facility;

FIG. 4 is a diagram illustrating the housing facility according to the first embodiment FIG. 4 illustrating a stored state of a landing platform;

FIG. 5 is a diagram for describing the landing platform moving from the stored state to a protruding state in the first embodiment;

FIG. 6 is a first diagram for describing the landing platform moving from the protruding state to the stored state in the first embodiment;

FIG. 7 is a second diagram for describing the landing platform moving from the protruding state to the stored state in the first embodiment;

FIG. 8 is a diagram for describing an example of changing an inclination of the landing platform relative to a horizontal direction;

FIG. 9 is a flowchart of a process performed by the server in a modification of the first embodiment to house the unmanned aircraft in the housing facility;

FIG. 10 is a first diagram for describing the landing platform moving from the protruding state to the stored state in the modification of the first embodiment;

FIG. 11 is a second diagram for describing the landing platform moving from the protruding state to the stored state in the modification of the first embodiment;

FIG. 12 is a diagram illustrating a schematic configuration of an information processing system according to a second embodiment;

FIG. 13 is a flowchart of a process performed by a server in the second embodiment to house an unmanned aircraft in a housing facility;

FIG. 14 is a diagram for describing a landing platform rotating to switch between a protruding part and a stored part in the second embodiment;

FIG. 15 is a diagram illustrating a schematic configuration of an information processing system according to a third embodiment; and

FIG. 16 is a diagram illustrating the structural elements of the information processing system according to the third embodiment in greater detail.

### DESCRIPTION OF THE EMBODIMENTS

In the disclosure of the present application, a controller of an information processing apparatus acquires landing information about landing of a flying object on a landing platform that is provided on a housing facility for housing the flying object, the landing platform being where the flying object lands when the flying object is to be housed in the housing facility. The landing platform is movable between a stored state of being stored in an inner space separated by an outer wall of the housing facility and a protruding state of protruding from the outer wall of the housing facility. Furthermore, the landing platform may be configured such that a part of the landing platform is stored in the inner space separated by the outer wall of the housing facility and a remaining part protrudes from the outer wall of the housing facility, and such that a protruding part, of the landing platform, that protrudes from the outer wail of the housing facility and a stored part, of the landing platform, that is stored in the inner space of the housing facility are switched by the landing platform rotating around a virtual axis that is substantially perpendicular to the landing platform. Additionally, the controller may acquire the landing information based on detected information detected by a sensor capable of detecting landing of the flying object on the landing platform.

For example, in the case where the landing platform is movable between the stored state and the protruding state, the controller issues a command for controlling the landing platform to be in the stored state, based on the acquired landing information. Here, the controller may issue the command for controlling the landing platform to be in the stored state, in the case where indication that the flying object landed on the landing platform is acquired. Furthermore, in the case where the protruding part and the stored part are to be switched by rotation of the landing platform, for example, the controller issues a command for controlling a rotation operation of the landing platform based on the acquired landing information. Here, the controller may issue the command for controlling the rotation operation of the landing platform, in the case where indication that the flying object landed on the landing platform is acquired.

With such an information processing apparatus, the flying object landing on the landing platform is stored in the inner space of the housing facility together with the landing platform. Then, by moving the stored flying object from the landing platform to an aircraft stand, a flying object may be enabled to land on the landing platform again. This allows flying objects to repeatedly land on the landing platform, and time required to house the flying objects in the housing facility may be reduced. As a result, use of flying objects may be promoted.

In the following, embodiments of the disclosure of the present, application will be described with reference to the drawings. Configurations of the following embodiments are merely examples, and the disclosure of the present application is not limited to the configurations of the embodiments.

### First Embodiment

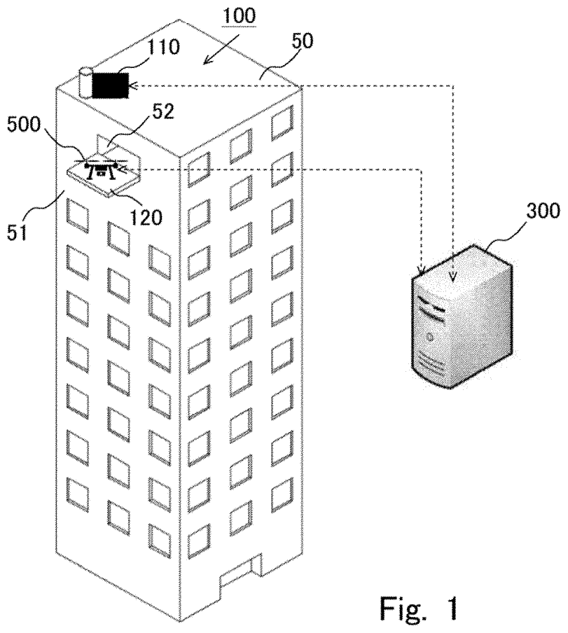

An outline of an information processing system according to a first embodiment will be given with reference to FIG. 1. The information processing system according to the present embodiment includes a housing apparatus 100 that manages entry, into a housing facility 50, of an unmanned aircraft 500 that is to be housed in the housing facility 50, and a server 300. The unmanned aircraft 500 according to the present embodiment is a multicopter including a plurality of rotors, that is, a so-called drone, but is not intended to be limited thereto and may be any type of aircraft as long as it is capable of hovering. Furthermore, the housing facility 50 according to the present embodiment is a high-rise building with an aircraft stand for parking the unmanned aircraft 500, but is not intended to be limited thereto and may be any type of building as long as it is a building with an aircraft stand for parking the unmanned aircraft 500.

The housing apparatus 100 is provided at the housing facility 50, and includes an aircraft-stand terminal device 110 and a landing platform 120. The landing platform 120 here allows the unmanned aircraft 500 to land thereon at the time of the unmanned aircraft 500 entering the housing facility 50. The landing platform 120 is movable between a stored state of being stored in an inner space 52 separated by an outer wall 51 of the housing facility 50 and a protruding state of protruding from the outer wall 51 of the housing facility 50, and such a landing platform 120 is controlled by the aircraft-stand terminal device 110. Details will be given later.

The server 300 is capable of communicating with the aircraft-stand terminal device 110 of the housing apparatus 100, and is capable of acquiring data that is transmitted from the aircraft-stand terminal device 110 and of transmitting a predetermined command to the aircraft-stand terminal device 110. Additionally, the predetermined command is a command for controlling the landing platform 120, for example. Furthermore, the server 300 is capable of communicating with the unmanned aircraft 500, and is capable of acquiring position information of the unmanned aircraft 500 based on data that is transmitted from the unmanned aircraft 500, for example.

The server 300 that is capable of communicating with the housing apparatus 100 as described above acquires landing information about landing of the unmanned aircraft 500 on the landing platform 120 based on data that is transmitted from the housing apparatus 100. Then, based on the acquired landing information, the server 300 issues a command for controlling the landing platform 120 to be in the stored state mentioned above. Here, the server 300 may issue the command for controlling the landing platform 120 to be in the stored state, in a case where indication that the unmanned aircraft 500 landed on the landing platform 120 is acquired.

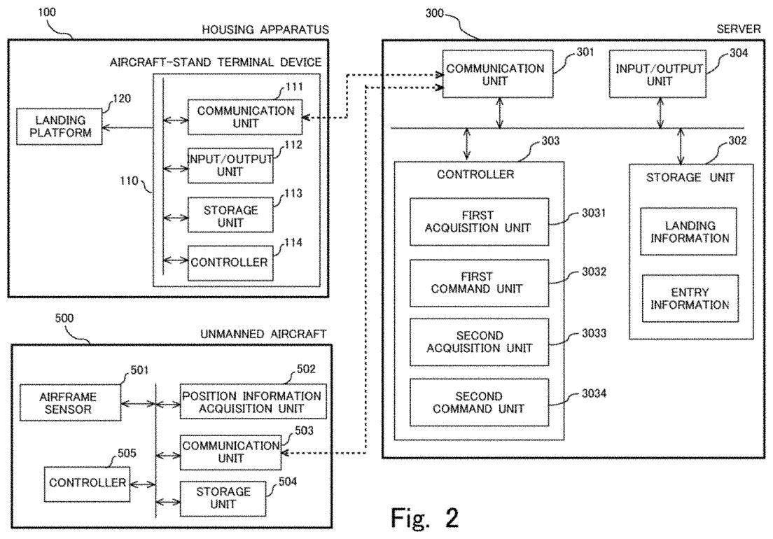

Next, structural elements of the server 300 will be mainly described in detail with reference to FIG. 2. FIG. 2 is a diagram illustrating, in greater detail, structural elements of the server 300 included in the information processing system according to the first embodiment, and is a diagram also illustrating structural elements of the housing apparatus 100 that performs communication with the server 300 and the unmanned aircraft 500 to be housed in the housing facility 50.

The server 300 may be a general-purpose computer. That is, the server 300 may be a computer that includes processors such as a CPU and a GPU, main memories such as a RAM and a ROM, and auxiliary memories such as an EPROM, a hard disk drive and a removable medium. Additionally, the removable medium may be an USB memory or a disk recording medium such as a CD or a DVD, for example. The auxiliary memory stores an operating system (OS), various programs, various tables and the like. The server 300 includes, as functional units, a communication unit 301, a storage unit 302, a controller 303, and an input/output unit 304, and may implement a function matching a predetermined purpose of each functional unit by loading a program stored in the auxiliary memory into a work, area of the main memory and executing the program and thereby controlling each functional unit and the like through execution of the program. However, one or some or all of functions may alternatively be implemented by a hardware circuit such as an ASIC or an FPGA.

The communication unit 301 is a communication interface for connecting the server 300 to a network. For example, the communication unit 301 includes a network interface board, a wireless communication circuit for wireless communication, or the like. The server 300 is communicably connected, via the communication unit 301, to the housing apparatus 100, the unmanned aircraft 500 and other external apparatuses.

The storage unit 302 includes the main memories and the auxiliary memories. The main memory is a memory where programs to be executed by the controller 303 and data to be used by the control programs are developed. The auxiliary memory is a unit where programs to be executed by the controller 303 and data to be used by the control programs are stored. The storage unit 302 further stores data pieces that are transmitted from the housing apparatus 100, the unmanned aircraft 500 and the like. Additionally, the server 300 acquires such data pieces via the communication unit 303.

The controller 303 is a functional unit that is in charge of control that is performed by the server 300. The controller 303 may be implemented by an arithmetic processing unit such as a CPU. The controller 303 further includes four functional units, namely, a first acquisition unit 3031, a first command unit 3032, a second acquisition unit 3033, and a second command unit 3034. Each functional unit may be implemented by the CPU executing a stored program.

The first acquisition unit 3031 acquires landing information about landing of the unmanned aircraft 500 on the landing platform 120. Here, the first acquisition unit 3031 may acquire the landing information based on detected information detected by a sensor that is capable of detecting landing of the unmanned aircraft 500 on the landing platform 120.

The sensor here is a contact sensor, a tactile sensor or a weight sensor that is provided on the landing platform 120, for example, and the first acquisition unit 3031 may acquire the landing information based on detected information that is detected by such a sensor and transmitted from the housing apparatus 100. Furthermore, the sensor that is capable of detecting landing of the unmanned aircraft 500 on the landing platform 120 may alternatively be provided on the unmanned aircraft 500, and in this case, the first acquisition unit 3031 may acquire the landing information based on detected information that is transmitted front the unmanned aircraft 500.

Additionally, the unmanned aircraft 500 according to the present embodiment is an autonomous mobile body that performs autonomous traveling based on a command from outside. In this case, the unmanned aircraft 500 includes an airframe sensor 501, a position information acquisition unit 502, a communication unit 503, a storage unit 504, and a controller 505. The airframe sensor 501 is means for sensing a state of an airframe and for sensing a periphery of the airframe. As the airframe sensor 501 for sensing the state of the airframe, there may be cited an accelerometer, a speedometer or an azimuth sensor. As the airframe sensor 501 for sensing the periphery of the airframe, there may be cited a stereo camera, a laser scanner, a LIDAR, a radar or the like. Information that is acquired by the airframe sensor 501 is transmitted to the controller 505. The position information acquisition unit 602 is means for acquiring a current position of the unmanned aircraft 500, and is typically a GPS (global positioning system) device that acquires position information by receiving GPS satellite signals. Position information that is obtained from the GPS device includes latitude, longitude and altitude. The position information acquisition unit 502 may be a positioning device based on a GNSS (global navigation satellite system), instead of the GPS, or a positioning device based on base station positioning as long as the current position of the unmanned aircraft 500 may be acquired. The communication unit 503 is a communication interface for connecting the unmanned aircraft 500 to a network, and includes a network interface board or a wireless communication circuit for wireless communication, for example. Like the storage unit 302 of the server 300, the storage unit 504 includes main memories and auxiliary memories, and airframe information of the unmanned aircraft 500 is registered in the storage unit 504. Additionally, registration of the airframe information is performed in advance through a predetermined application. The controller 505 is a computer that controls autonomous traveling of the unmanned aircraft 500. The controller 505 includes a microprocessor and a memory storing programs, for example, and functions by the microprocessor executing the programs. Additionally, one or some or all of functions may he implemented by a logic circuit such as an ASIC (application specific integrated circuit) or a FPGA (field programmable gate array). However, the unmanned aircraft 500 is not intended to be limited to such an autonomous mobile body, and the unmanned aircraft 500 may alternatively be operated by a user.

The first command unit 3032 issues a command for controlling the landing platform 120 to be in the stored state mentioned above, based on the landing information acquired by the first acquisition unit 3031. Here, the first command unit 3032 may issue the command for controlling the landing platform 120 to be in the stored state, in a case where indication that the unmanned aircraft 500 landed on the landing platform 120 is acquired as the landing information. Additionally, in the present embodiment, the first command unit 3032 issues the command for controlling the landing platform 120 to be in the stored state to the housing apparatus 100.

As described above, the housing apparatus 100 includes the aircraft-stand terminal device 110 and the landing platform 120. As illustrated in FIG. 2, the aircraft-stand terminal device 110 includes, as functional units, a communication unit 111, an input/output unit 112, a storage unit 113, and a controller 114, but may further include other functional units. The communication unit 111 is a communication Interface for connecting the housing apparatus 100 to a network, and includes a network interface board or a wireless communication circuit for wireless communication, for example. The input/output unit 112 is a functional unit that displays information and the like received from outside via the communication unit 111 and that is used to input information at the time of transmitting information to outside via the communication unit 111, and includes a display device and a touch panel, for example. Like the storage unit 302 of the server 300, the storage unit 113 includes main memories and auxiliary memories, and information about the unmanned aircraft 500 to be housed in the housing facility 50 is registered in the storage unit 113. Additionally, registration of the information is performed in advance through a predetermined application. The controller 114 is a functional unit that controls the landing platform 120.

The aircraft-stand terminal device 110 of the housing apparatus 100 receiving, from the server 300, the command for controlling the landing platform 120 to be in the stored state controls the landing platform 120 to be in the stored state. The unmanned aircraft 500 landing on the landing platform 120 is thus stored in the inner space 52 of the housing facility 50 together with the landing platform 120. That is, the unmanned aircraft 500 is housed in the housing facility 50.

The second acquisition unit 3033 acquires entry information about entry, into the housing facility 50, of an unmanned aircraft 500 in flight. Here, the second acquisition unit 3033 may acquire, as the entry information, a schedule of entry of the unmanned aircraft 500 into the housing facility 50, based on an operation plan of the unmanned aircraft 500. As described above, the unmanned aircraft 500 according to the present embodiment is an autonomous mobile body that performs autonomous traveling based on a command from outside. The controller 505 of the unmanned aircraft 500 controls flight of the unmanned aircraft 500 based on an operation plan from outside, the state of the airframe and the peripheral state of the airframe acquired by the airframe sensor 501, and the position information of the airframe acquired by the position information acquisition unit 502. Additionally, in the present embodiment, the operation plan is data specifying a route of flight of the unmanned aircraft 500 and processes that, the unmanned aircraft 500 is to perform along parts of the route. The second acquisition unit 3033 may acquire the operation plan of the unmanned aircraft 500 from the unmanned aircraft 500 or from an external server, and may acquire the schedule of entry of the unmanned aircraft 500 into the housing facility 50.

Furthermore, the second acquisition unit 3033 may acquire, as the entry information, the schedule of entry of the unmanned aircraft 500 into the housing facility 50, based on the position information of the unmanned aircraft 500. In this case, the position information of the unmanned aircraft 500 is transmitted to the server 300. Additionally, in addition to the position information, the airframe information of the unmanned aircraft 500 is transmitted from the unmanned aircraft 500. Then, the second acquisition unit 3033 may acquire the schedule of entry of the unmanned aircraft 500 into the housing facility 50 by checking the position information indicating the current position of the unmanned aircraft 500 against position information indicating the location of the housing facility 50.

Furthermore, the second acquisition unit 3033 may acquire, as the entry information, the schedule of entry of the unmanned aircraft 500 into the housing facility 50, based on information that is detected through wireless communication between the unmanned aircraft 500 and the housing apparatus 100. In this case, when the unmanned aircraft 500 approaches the housing facility 50 where the housing apparatus 100 is provided, wireless communication is performed between the communication unit 503 of the unmanned aircraft 500 and the communication unit 111 provided in the aircraft-stand terminal device 110 of the housing apparatus 100. These communication units perform data communication according to Bluetooth (registered trademark) Low Energy standard (hereinafter “BLE”), for example. BLE is a low-power communication standard based on Bluetooth (registered trademark), and is characteristic in that devices may swiftly start communication upon detecting the counterpart, without having to be paired with each other. Additionally, in the present embodiment, BLE is cited as an example, but other wireless communication standards may also be used. For example, NFC (near field communication), UWB (ultra wideband) and WiFi (registered trademark) may also be used. The housing apparatus 100 acquires information that is detected through such wireless communication, and transmits the information to the server 300. Additionally, information that is transmitted from the housing apparatus 100 to the server 300 includes the airframe information of the unmanned aircraft 500 that is acquired by wireless communication by the housing apparatus 100. This enables the second acquisition unit 3033 to acquire the schedule of entry of the unmanned aircraft 500 into the housing facility 50 based on the information that is detected through wireless communication between the unmanned aircraft 500 and the housing apparatus 100. In this case, the communication unit 503 of the unmanned aircraft 500 corresponds to “first sensor” according to the present disclosure, and the communication unit 111 provided in the aircraft-stand terminal device 110 of the housing apparatus 100 provided at the housing facility 50 corresponds to “second sensor” according to the present disclosure.

The second command unit 3034 issues a command for controlling the landing platform 120 to be in the protruding state mentioned above, based on the entry information acquired by the second acquisition unit 3033. Additionally, in the present embodiment, the second command unit 3034 issues the command for controlling the landing platform 120 to be in the protruding state to the housing apparatus 100. Then, the aircraft-stand terminal device 110 of the housing apparatus 100 receiving, from the server 300, the command for controlling the landing platform 120 to be in the protruding state controls the landing platform 120 to be in the protruding state. Landing of the unmanned aircraft 500 on the landing platform 120 is thereby enabled.

Additionally, the controller 303 functions as the controller according to the present disclosure by performing the processes of the first acquisition unit 3031, the first command unit 3032, the second acquisition unit 3033, and the second command unit 3034. The server 300 functions as the information processing apparatus according to the present disclosure.

The input/output unit 304 is an interface used to input and output information. For example, the input/output unit 304 includes a display device and a touch panel. The input/output unit 304 may further include a keyboard, near-field communication means, a touch screen and the like.

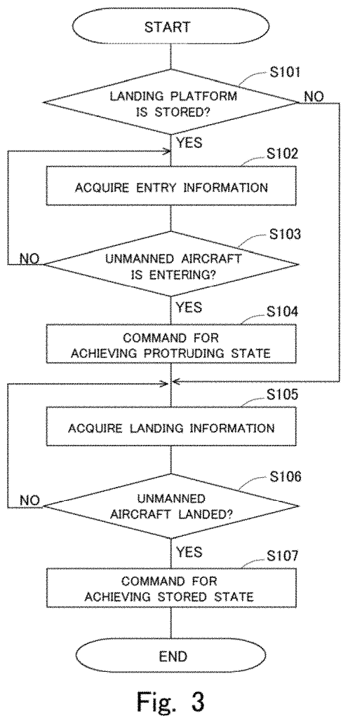

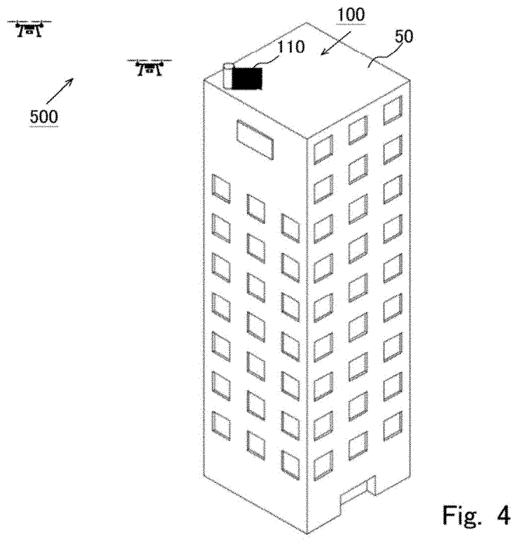

A process to be performed by the server 300 according to the first embodiment to house the unmanned aircraft 500 in the housing facility 50 will be described with reference to the flowchart in FIG. 3. This process is performed by the controller 303 of the server 300. First, in S101, whether the landing platform 120 of the housing apparatus 100 is in the stored state is determined. FIG. 4 is a diagram illustrating the housing facility 50 in the first embodiment, where the landing platform 120 is in the stored state. As illustrated in FIG. 4, when the landing platform 120 is housed inside the housing facility 50, the unmanned aircraft 500 is not able to enter the housing facility 50. Accordingly, the controller 303 communicates with the aircraft-stand terminal device 110 that controls the landing platform 120 and acquires a controlled state of the landing platform 120, and thus performs the determination mentioned above. When a positive determination is made in S101, the process proceeds to S102, and when a negative determination is made in S101, the process proceeds to S105.

In the case where a positive determination is made in S101, the entry information about, entry, into the housing facility 50, of the unmanned aircraft 500 in flight is acquired in S102. For example, the controller 303 may acquire the entry information by acquiring, from the housing apparatus 100, information that is detected through wireless communication between the unmanned aircraft 500 and the housing apparatus 100. Then, in S103, whether the unmanned aircraft 500 is entering the housing facility 50 will be determined based on the entry information acquired by the process in S102. When a positive determination is made in S103, the process proceeds to S104, and when a negative determination is made in S103, the process returns to S102.

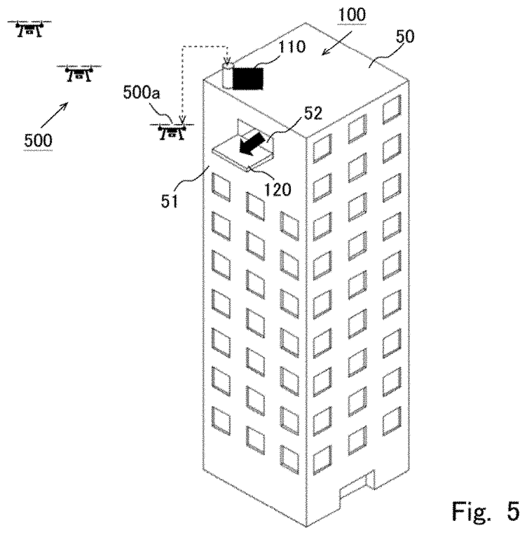

In the case where a positive determination is made in S103, the command for controlling the landing platform 120 to be in the protruding state is issued to the housing apparatus 100 in S104. FIG. 5 is a diagram for describing the landing platform 120 moving from the stored state to the protruding state in the first embodiment. As can be seen in FIG. 5, wireless communication is performed between the housing apparatus 100 and an unmanned aircraft 500a among unmanned aircrafts 500. At this time, the controller 303 of the server 300 acquires that the unmanned aircraft 500a is scheduled to enter the housing facility 50, and issues the command for controlling the landing platform 120 to be in the protruding state to the housing apparatus 100. Then, the aircraft-stand terminal device 110 of the housing apparatus 100 receiving, from the server 300, the command for controlling the landing platform 120 to be in the protruding state controls the landing platform 120 to be in the protruding state. As illustrated in FIG. 5, the landing platform 120 of the present embodiment moves in a substantially horizontal direction from a state of being stored in the inner space 52 separated by the outer wail 51 of the housing facility 50 (the stored state) toward outside of the outer wail 51, and the protruding state where the landing platform 120 protrudes from the outer wall 51 of the housing facility 50 is thereby reached. Then, when the process in S104 ends, the process proceeds to S105.

In S105, the landing information about landing of the unmanned aircraft 500 on the landing platform 120 is acquired. The controller 303 may acquire the landing information based on detected information detected by the sensor that is capable of detecting landing of the unmanned aircraft 500 on the landing platform 120. Then, in S106, whether the unmanned aircraft 500 landed on the landing platform 120 is determined based on the landing information acquired by the process in S105. When a positive determination is made in S106, the process proceeds to S107, and when a negative determination is made in S106, the process returns to S105.

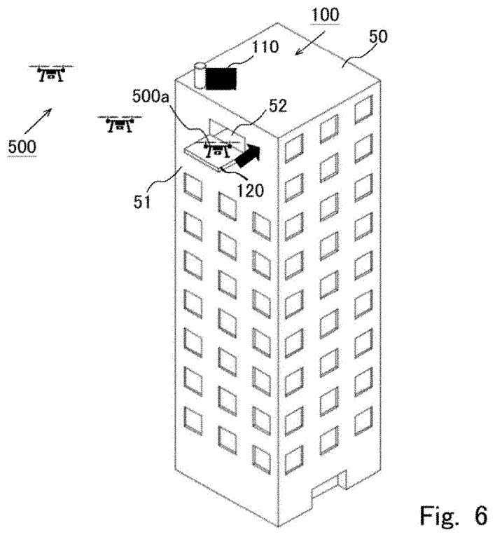

In the case where a positive determination is made in S106, the command for controlling the landing platform 120 to be in the stored state is issued to the housing apparatus 100 in S107. FIG. 6 is a first diagram for describing the landing platform 120 moving from the protruding state to the stored state in the first embodiment. As can be seen in FIG. 6, the unmanned aircraft 500a, among the unmanned aircrafts 500, is landed on the landing platform 120. At this time, as described above, the controller 303 of the server 300 acquires indication that the unmanned aircraft 500a landed on the landing platform 120. Then, the controller 303 issues the command for controlling the landing platform 120 to be in the stored state to the housing apparatus 100. Then, the aircraft-stand terminal device 110 of the housing apparatus 100 receiving, from the server 300, the command for controlling the landing platform 120 to be in the stored state controls the landing platform 120 to be in the stored state. As illustrated in FIG. 6, the landing platform 120 of the present embodiment moves in the substantially horizontal direction from a state of protruding from the outer wall 51 of the housing facility 50 (the protruding state) toward inside of the outer wall 51, and the stored state where the landing platform 120 is stored in the inner space 52 of the housing facility 50 is thereby reached. Then, the unmanned aircraft 500a that landed on the landing platform 120 is stored in the inner space 52 of the housing facility 50 together with the landing platform 120. That is, the unmanned aircraft 500a is housed inside the housing facility 50.

Then, when the unmanned aircraft 500a that is stored in the inner space 52 of the housing facility 50 together with the landing platform 120 is moved from the landing platform 120 to the aircraft stand, an unmanned aircraft 500 may be enabled to land on the landing platform 120 that is placed in the protruding state again Landing of the unmanned aircraft 500 on the landing platform 120 may thereby be repeatedly performed even if the landing platform 120 is relatively small, and time required to house the unmanned aircrafts 500 in the housing facility 50 may be reduced. As a result, use of flying objects may be promoted.

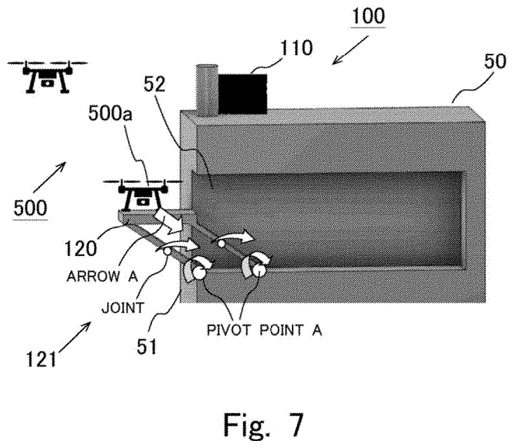

Additionally, the landing platform 120 is, but not limited to be, movable in the substantially horizontal direction. FIG. 7 is a second diagram for describing the landing platform 120 moving from the protruding state to the stored state in the first embodiment. The landing platform 120 in FIG. 7 is illustrated to be in a state of protruding from the outer wall 51 of the housing facility 50 (the protruding state) and is supported by a link mechanism 121 including pivot points A and joints. When the landing platform 120 as described is controlled to be in the stored state, the link mechanism 121 is rotated around the pivot points A and the joints are bent, and the landing platform 120 is thereby moved in a direction of an arrow A, and the stored state where the landing platform 120 is stored in the inner space 52 of the housing facility 50 is reached.

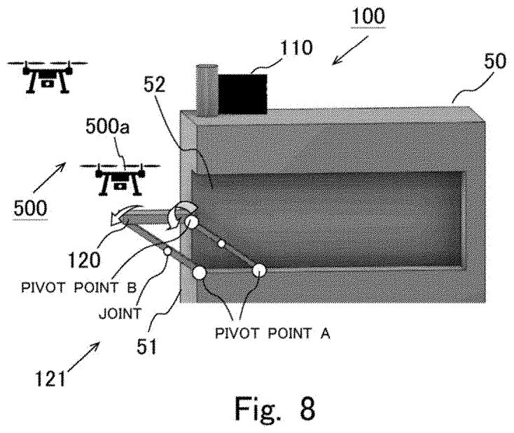

Furthermore, the controller 303 of the server 300 may issue, to the housing apparatus 100, a command for controlling an inclination of the landing platform 120 relative to a horizontal direction, depending on attitude of the unmanned aircraft 500 at the time of the unmanned aircraft 500 landing on the landing platform 120. Such a change in the inclination is enabled when the landing platform 120 is supported by the link mechanism 121 as illustrated in FIG. 7 described above. FIG. 8 is a diagram for describing an example of changing the inclination of the landing platform 120 relative to the horizontal direction. As can be seen in FIG. 8, pivot points B of the link mechanism 121 are provided at connecting parts between the landing platform 120 and the link mechanism 121. This enables the landing platform 120 to rotate around the pivot points B. When the landing platform 120 is rotated around the pivot points B, the inclination of the landing platform 120 relative to the horizontal direction is changed. Additionally, the server 300 may acquire, by communicating with the unmanned aircraft 500, information about the attitude of the unmanned aircraft 500 detected by the airframe sensor 501 capable of sensing the state of the airframe of the unmanned aircraft 500. Then, the server 300 may issue, to the housing apparatus 100, the command for controlling the inclination of the landing platform 120 relative to the horizontal direction such that, for example, an inclination, relative to the horizontal direction, of a part of the unmanned aircraft 500 that is to come into contact with the landing platform 120 and the inclination of the landing platform 120 relative to the horizontal direction substantially coincide with each other.

A description has been given above of an example of a case where the flying object is an unmanned flying object, but the flying object according to the present embodiment may be a manned flying object. Such a manned flying object may be an autonomous mobile body that performs autonomous traveling, or may be operated by a user. For example, in the case where the manned flying object is to be operated by a user, the server 300 may transmit, to the manned flying object, information about a course to be taken by the manned flying object to land on the landing platform 120. Then, the course for entering the landing platform 120 may be displayed on a head-up display of the manned flying object, and convenience of the user may be increased.

### Modification of First Embodiment

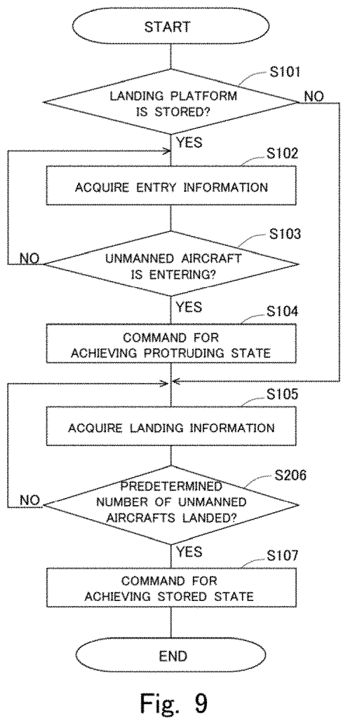

A modification of the first embodiment described above will be described with reference to FIGS. 9 to 11. In the present modification, in the case where the first acquisition unit 3031 acquires, as the landing information, indication that a plurality of unmanned aircrafts 500 landed on the landing platform 120, the first command unit 3032 issues the command for controlling the landing platform 120 to be in the stored state. Description is given below.

FIG. 9 is a flowchart of a process performed by the server 300 in the present modification to house the unmanned aircraft 500 in the housing facility 50. This process is performed by the controller 303 of the server 300. Additionally, processes illustrated in FIG. 9 that are substantially the same as the processes illustrated in FIG. 3 described above are denoted by same reference signs, and a detailed description thereof is omitted.

In the present modification, when the landing information about landing of an unmanned aircraft 500 on the landing platform 120 is acquired by the process in S105, whether a predetermined number of unmanned aircrafts 500 have landed on the landing platform 120 is determined in S206 based on the landing information acquired by the process in S105. The predetermined number here is the number of unmanned aircrafts 500 that can be accommodated on one landing platform 120 at the same time, for example, and in the present modification, the predetermined number is three as will be described later. When a positive determination is made in S206, the process proceeds to S107, and when a negative determination is made in S206, the process returns to S105. Then, in the case where a positive determination is made in S206, the command for controlling the landing platform 120 to be in the stored state is issued to the housing apparatus 100 in S107.

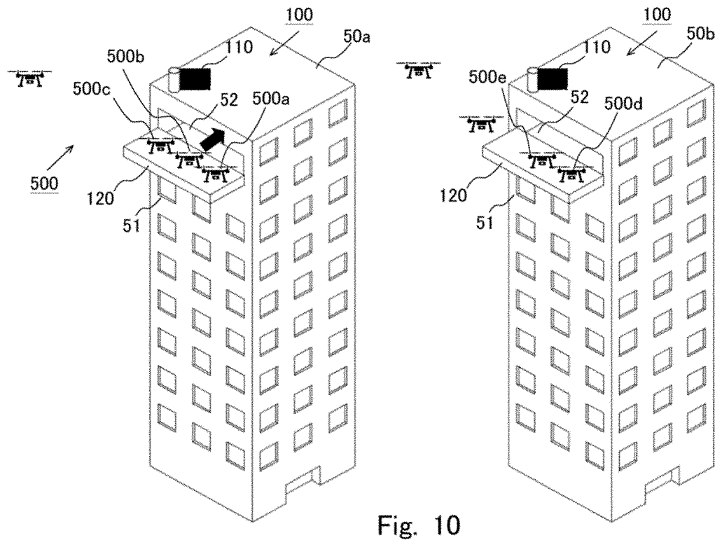

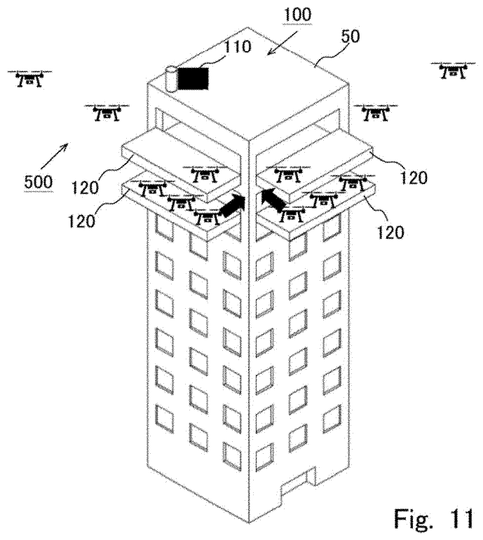

Processes described above will be described with reference to FIGS. 10 and 11. FIG. 10 is a first diagram for describing the landing platform 120 moving from the protruding state to the stored state in the modification of the first embodiment. As can be seen in FIG. 10, three unmanned aircrafts 500 (unmanned aircraft 500a to 500c) are landed on the landing platform 120 of housing facility 50a. The number of unmanned aircrafts 500 that can be accommodated on the landing platform 120 at the same time (i.e., the predetermined number mentioned above) is three. Accordingly, the controller 303 of the server 300 determines, by the process in S206, that the predetermined number of unmanned aircrafts 500 are landed on the landing platform 120, and issues, by the process in S107, the command for controlling the landing platform 120 to be in the stored state to the housing apparatus 100. Then, the aircraft-stand terminal device 110 of the housing apparatus 100 receiving the command for controlling the landing platform 120 to be in the stored state from the server 300 controls the landing platform 120 to be in the stored state, and the three unmanned aircrafts 500 landed on the landing platform 120 are thus stored in the inner space 52 of the housing facility 50a together with the landing platform 120. Furthermore, as can be seen in FIG. 10, two unmanned aircrafts 500 (unmanned aircrafts 500d and 500e) are landed on the landing platform 120 of a housing facility 30b. In this case, one more aircraft may be accommodated on the landing platform 120 of the housing facility 50b. Accordingly, the controller 303 of the server 300 determines, by the process in S206, that the predetermined number of unmanned aircrafts 500 are not landed on the landing platform 120.

FIG. 11 is a second diagram for describing the landing platform 120 moving from the protruding state to the stored state in the modification of the first embodiment. As can be seen in FIG. 11, the housing facility 50 is provided with a plurality of landing platforms 120. Also, in this case, as in FIG. 10 described above, a landing platform 120 where three unmanned aircrafts 500 are landed is controlled to move from the protruding state to the stored state.

As described above, a relatively large number of unmanned aircrafts 500 are enabled to land on the landing platform 120, and time required to house the unmanned aircrafts 500 in the housing facility 50 may be reduced. As a result, use of flying objects may be promoted.

### Second Embodiment

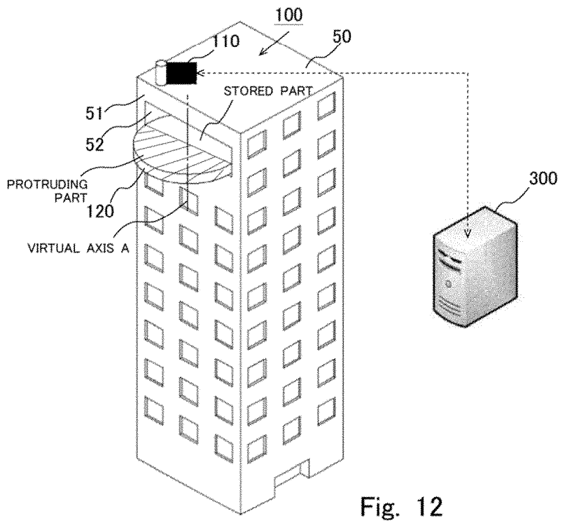

A second embodiment will be described with reference to FIGS. 12 to 14. In the first embodiment described above, the landing platform 120 is movable between the stored state of being stored in the inner space 52 separated by the outer wall 51 of the housing facility 50 and the protruding state of protruding from the outer wall 51 of the housing facility 50. In contrast, in the present embodiment, the landing platform 120 is rotated around a virtual axis that is substantially perpendicular to the landing platform 120 such that a protruding part, of the landing platform 120, protruding from the outer wall 51 of the housing facility 50 and a stored part, of the landing platform 120, that is stored in the inner space 52 are switched. A description will be given with reference to FIG. 12.

FIG. 12 is a diagram illustrating a schematic configuration of an information processing system according to the second embodiment. As illustrated in FIG. 12, the landing platform 120 according to the present embodiment is formed into a disc shape, and is capable of rotating around a virtual axis A that extends in a direction substantially perpendicular to the landing platform 120 from a center of the disc. The landing platform 120 is accommodated in the housing facility 50 in such a manner that a part thereof is housed in the inner space 52 separated by the outer wail 51 of the housing facility 50 and the remaining part protrudes from the outer wall 51 of the housing facility 50. Then, when the landing platform 120 rotates around the virtual axis A, the protruding part, of the landing platform 120, protruding from the outer wall 51 of the housing facility 50 (a shaded part of the landing platform 120 in FIG. 12) and the stored part, of the landing platform 120, that is stored in the inner space 52 are switched.

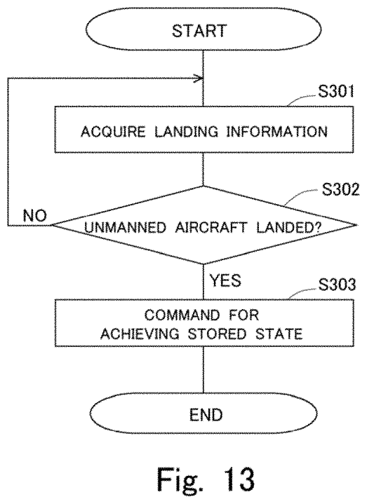

FIG. 13 is a flowchart of a process performed by the server 300 in the second embodiment to house the unmanned aircraft 500 in the housing facility 50. This process is performed by the controller 303 of the server 300. First, in S301, the landing information about landing of the unmanned aircraft 500 on the landing platform 120 is acquired. Additionally, the process in S301 is substantially the same as the process in S105 in FIG. 3 described above. Then, in S302, whether the unmanned aircraft 500 landed on the landing platform 120 is determined based on the landing information acquired by the process in S301. When a positive determination is made in S302, the process proceeds to S303, and when a negative determination is made in S302, the process returns to S301.

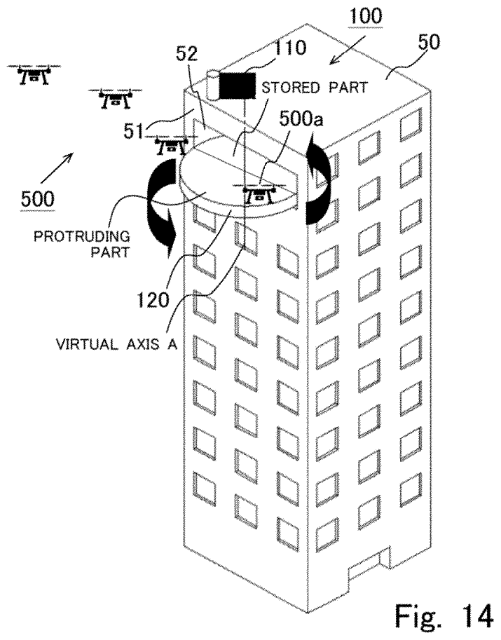

In the case where a positive determination is made in S302, a command for controlling a rotation operation of the landing platform 120 is issued to the housing apparatus 100 in S303. FIG. 14 is a diagram for describing the landing platform 120 rotating to switch between the protruding part and the stored part in the second embodiment. As can be seen in FIG. 14, of the unmanned aircrafts 500, an unmanned aircraft 500a is landed on the landing platform 120. At this time, the controller 303 of the server 300 acquires indication that the unmanned aircraft 500a landed on the landing platform 120. Then, the controller 303 issues the command for controlling the rotation operation of the landing platform 120 to the housing apparatus 100. Then, the aircraft-stand terminal device 110 or the housing apparatus 100 receiving the command for controlling the rotation operation of the landing platform 120 from the server 300 rotates the landing platform 120 such that the protruding part and the stored part of the landing platform 120 are switched. The unmanned aircraft 500a landed on the protruding part of the landing platform 120 is thus stored, by the rotation operation of the landing platform 120, in the inner space 52 of the housing facility 50 together with the protruding part of the landing platform 120. That is, the unmanned aircraft 500a is housed in the housing facility 50.

Then, when the unmanned aircraft 500a that is stored in the inner space 52 of the housing facility 50 together with the landing platform 120 is moved from the landing platform 120 to the aircraft stand, an unmanned aircraft 500 may be enabled to land on the protruding part of the landing platform 120 again. Landing of the unmanned aircraft 500 on the landing platform 120 may thereby be repeatedly performed, and time required to house the unmanned aircrafts 500 in the housing facility 50 may be reduced. As a result, use of flying objects may be promoted.

Additionally, also in the present embodiment, in the case where the first acquisition unit 3031 acquires, as the landing information, indication that a plurality of unmanned aircrafts 500 landed on the landing platform 120, the first command unit 3032 may issue the command for controlling the rotation operation of the landing platform 120. A relatively large number of unmanned aircrafts 500 may thus be landed on the landing platform 120, and Lime required to house the unmanned aircrafts 500 in the housing facility 50 may be reduced. As a result, use of flying objects may be promoted.

### Third Embodiment

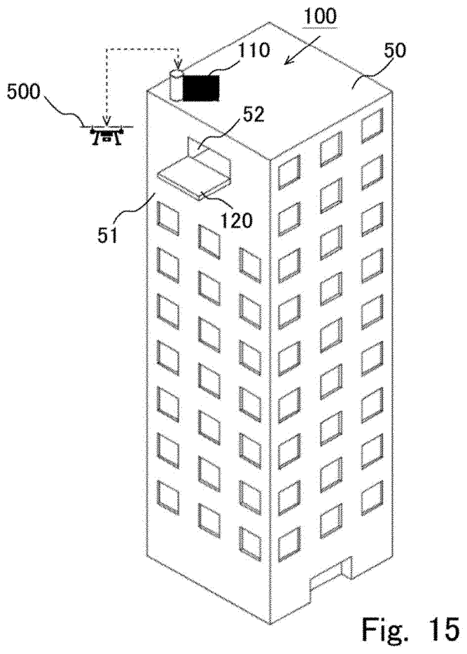

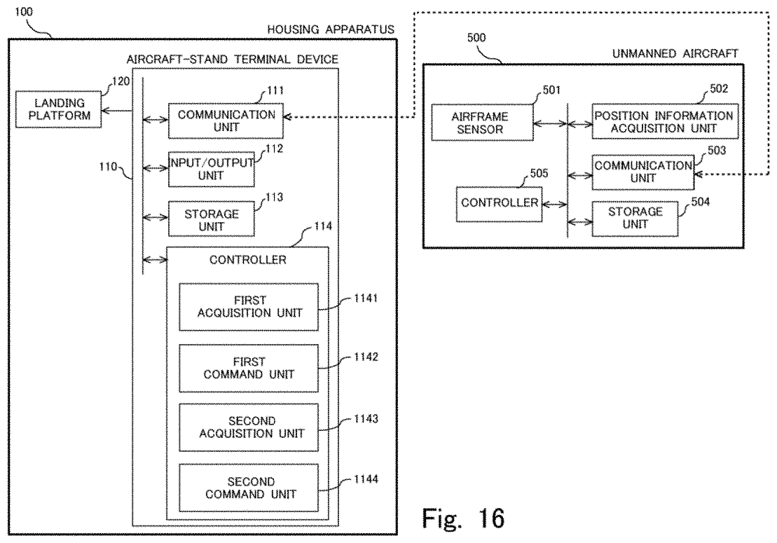

A third embodiment will be described with reference to FIGS. 15 and 16. FIG. 15 is a diagram illustrating a schematic configuration of an information processing system according to the third embodiment. FIG. 16 is a diagram illustrating structural elements of the housing apparatus 100 included in the information processing system according to the third embodiment in greater detail, and also illustrating structural elements of the unmanned aircraft 500 that communicates with the housing apparatus 100.

In the first embodiment described above, an example is described where the process for housing the unmanned aircraft 500 in the housing facility 50 is performed by the server 300. In contrast, in the present embodiment, an example is described where the process for housing the unmanned aircraft 500 in the housing facility 50 is performed by the housing apparatus 100.

The controller 114 of the aircraft-stand terminal device 110 provided in the housing apparatus 100 is a functional unit that is in charge of control that is performed by the aircraft-stand terminal device 110. The controller 114 may be implemented by an arithmetic processing unit such as a CPU. As illustrated in FIG. 16 the controller 114 further includes four functional units namely, a first acquisition unit 1141, a first command unit 1142, a second acquisition unit 1143, and a second command unit 1144. Each functional unit may be implemented by the CPU executing a program that is stored.

The first acquisition unit 1141 acquires the landing information about landing of the unmanned aircraft 500 on the landing platform 120. The first acquisition unit 1141 may acquire the landing information based on detected information detected by the sensor that is capable of detecting landing of the unmanned aircraft 500 on the landing platform 120.

The first command unit 1142 issues the command for controlling the landing platform 120 to be in the stored state, based on the landing information acquired by the first acquisition unit 1141. In the present embodiment, when the first command unit 1142 issues the command for controlling the landing platform 120 to be in the stored state, a drive unit for moving the landing platform 120 is operated.

The second acquisition unit 1143 acquires the entry information about entry, into the housing facility 50, of the unmanned aircraft 500 in flight. Here, the second acquisition unit 1143 may acquire, as the entry information, the schedule of entry of the unmanned aircraft 500 into the housing facility 50, based on information that is detected through wireless communication between the unmanned aircraft 500 and the housing apparatus 100. In this case, when the unmanned aircraft 500 approaches the housing facility 50 where the housing apparatus 100 is provided, wireless communication is performed between the communication unit 503 of the unmanned aircraft 500 and the communication unit 111 provided in the aircraft-stand terminal device 110 of the housing apparatus 100. The second acquisition unit 1143 may acquire the entry information by acquiring information that is detected through such wireless communication.

The second command unit 1144 issues the command for controlling the landing platform 120 to be in the protruding state, based on the entry information acquired by the second acquisition unit 1143. In the present embodiment, when the second command unit 1144 issues the command for controlling the landing platform 120 to be in the protruding state, the drive unit for moving the landing platform 120 is operated.

Then, a process the same as the process for housing the unmanned aircraft 500 in the housing facility 50 described in the first embodiment with reference to FIG. 3 is performed by the controller 114 of the aircraft-stand terminal device 110 provided in the housing apparatus 100. Then, the unmanned aircraft 500 landing on the landing platform 120 is stored in the inner space 52 of the housing facility 50 together with the landing platform 120. Then, when the unmanned aircraft 500 that is stored in the inner space 52 of the housing facility 50 together with the landing platform 120 is moved from the landing platform 120 to the aircraft stand, an unmanned aircraft 500 may be enabled to land on the landing platform 120 that is placed in the protruding state again. Landing of the unmanned aircraft 500 on the landing platform 120 may thereby be repeatedly performed even if the landing platform 120 is relatively small, and time required to house the unmanned aircrafts 500 in the housing facility 50 may be reduced. As a result, use of flying objects may be promoted.

### Other Embodiments

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus nay be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising a controller configured to:
acquire landing information about landing of a flying object on a landing platform that is provided on a housing facility for housing the flying object, the landing platform being where the flying object lands when the flying object is to be housed in the housing facility, the landing platform being movable between a stored state of being stored in an inner space separated by an outer wall of the housing facility and a protruding state of protruding from the outer wall of the housing facility, and
issue a command for controlling the landing platform to be in the stored state, based on the landing information.

2. The information processing apparatus according to claim 1, wherein the controller acquires the landing information based on detected information detected by a sensor that is capable of detecting landing of the flying object on the landing platform.

3. The information processing apparatus according to claim 1, wherein the controller issues the command for controlling the landing platform to be in the stored state, in a case where indication that the flying object landed on the landing platform is acquired as the landing information.

4. The information processing apparatus according to claim 1, wherein the controller issues the command for controlling the landing platform to be in the stored state, in a case where indication that a plurality of the flying objects landed on the landing platform is acquired as the landing information.

5. The information processing apparatus according to claim 1, wherein the controller acquires entry information about entry, into the housing facility, of the flying object in flight, and issues a command for controlling the landing platform to fee in the protruding state, based on the entry information.

6. The information processing apparatus according to claim 5, wherein the controller acquires, as the entry information, a schedule of entry of the flying object into the housing facility, based on an operation plan of the flying object.

7. The information processing apparatus according to claim 5, wherein the controller acquires, as the entry information, a schedule of entry of the flying object into the housing facility, based on position information of the flying object.

8. The information processing apparatus according to claim 5, wherein the controller acquires, as the entry information, a schedule of entry of the flying object into the housing facility, based on information detected by wireless communication between a first sensor provided in the flying object and a second sensor provided at the housing facility.

9. The information processing apparatus according to claim 1, wherein the landing platform is movable in a substantially horizontal direction.

10. The information processing apparatus according to claim 1, wherein the controller issues a command for controlling the landing platform to a housing apparatus that is an apparatus provided at the housing facility and that is configured to control the landing platform.

11. An information processing apparatus comprising a controller configured to:
acquire landing information about landing of a flying object on a landing platform that is provided on a housing facility for housing the flying object, the landing platform being where the flying object lands when the flying object is to be housed in the housing facility the landing platform including a part that is stored in an inner space separated by an outer wall of the housing facility and a remaining part that protrudes from the outer wall of the housing facility, the landing platform being rotated around a virtual axis that is substantially perpendicular to the landing platform such that a protruding part, of the landing platform, that protrudes from the outer wall of the housing facility and a stored part, of the landing platform, that is stored in the inner space of the landing platform are switched, and
issue a command for controlling a rotation operation of the landing platform, based on the landing information

12. The information processing apparatus according to claim 11, wherein the controller acquires the landing information based on detected information detected by a sensor that is capable of detecting landing of the flying object on the landing platform.

13. The information processing apparatus according to claim 11, wherein the controller issues the command for controlling the rotation operation of the landing platform, in a case where indication that the flying object landed on the landing platform is acquired as the landing information.

14. The information processing apparatus according to claim 11, wherein the controller issues the command for controlling the rotation operation of the landing platform, in a case where indication that a plurality of the flying objects landed on the landing platform la acquired as the landing information.

15. The information processing apparatus according to claim 11, wherein the controller issues a command for controlling the landing platform to a housing apparatus that is an apparatus provided at the housing facility and that is configured to control the landing platform.

16. The information processing apparatus according to claim 1, wherein the controller issues a command for controlling an inclination of the landing platform relative to a horizontal direction, depending on attitude of the flying object at a time of the flying object landing on the landing platform.

17. The information processing apparatus according to claim 1, wherein the flying object is an unmanned flying object.

18. The information processing apparatus according to claim 1, wherein the flying object is a manned flying object.

19. The information processing apparatus according to claim 1, wherein the flying object is an autonomous mobile body that performs autonomous traveling based on a command from outside.

20. An information processing method performed by a computer, the method comprising:
acquiring landing information about landing of a flying object on a landing platform that, is provided on a housing facility for housing the flying object, the landing platform being where the flying object lands when the flying object is to be housed in the housing facility, the landing platform being movable between a stored state of being stored in an inner space separated by an outer wall of the housing facility and a protruding state of protruding from the outer wall of the housing facility, and
issuing a command for controlling the landing platform to be in the stored state, based on the landing information.
